(19) United States
(12) Patent Application Publication
(10) Pub. No.: US 2022/0108373 A1
(43) Pub. Date: Apr. 7, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Masahiro SATO, Kanagawa (JP)

(73) Assignee: FUJIFILM Business Innovation Corp., Tokyo (JP)

(21) Appl. No.: 17/335,750

(22) Filed: Jun. 1, 2021

(30) Foreign Application Priority Data
Oct. 1, 2020 (JP) 2020-167341

(51) Int. Cl. G06Q 30/06; G06F 16/28

(52) U.S. Cl. CPC G06Q 30/0631; G06K 9/628; G06F 16/285

(57) ABSTRACT

An information processing apparatus includes: a processor configured to: acquire a recommendation history indicating, for a combination of each of any users and each of any objects, whether the object has been recommended to the user, and a selection history indicating, for a combination of each of the any users and each of the any objects, whether the user has selected the object; and calculate, for each of the any objects, a difference between (i) a selection rate when the object has been recommended to similar users of the any users, similarities of the any users to a specific user being obtained based on the recommendation history and the selection history, the similarities of the similar users meeting a predetermined criterion, and (ii) a selection rate when the object has not been recommended to the similar users.

### CROSS-REFERENCE TO RELATED APPLICATIONS

This application is based on and claims priority under 35 USC 119 from Japanese Patent Application No. 2020-167341 filed Oct. 1, 2020.

### BACKGROUND

### (i) Technical Field

The present disclosure relates to an information processing apparatus and a non-transitory computer readable medium.

### (ii) Related Art

JP-B-5277307 discloses an information recommendation method in which a server provided with a processing unit and a storage unit is used to reflect the reaction of a user who receives information about an item in the selection criteria of the next recommended item and perform a separate recommendation. In the information recommendation method, the processing unit collects information to which the user has reacted and information to which the user has not reacted, compares both the item of interest to which the user has reacted and the item of indifference to which the user has not reacted, with respect to the unrecommended item, and determines which item has a higher similarity, and determines the next recommended item for the user using the comparison result.

Further, JP-B-6728972 discloses a program that causes a computer to implement a function of obtaining the number of purchases of a specific product by a first consumer who receives a recommendation for the specific product within a recommendation period based on the sales history read from a storage device, a function of obtaining the number of purchases of the specific product by a second consumer who does not receive a recommendation for the specific product during the recommendation period based on the sales history read from the storage device, a function of calculating an index value representing each consumer's preference for the specific product for each of the first consumer and the second consumer, a function of calculating the number of first purchases representing a group of first consumers and the number of second purchases representing a group of second consumers for each index value, a function of specifying the index value in which the increase amount of the number of first purchases with respect to the number of second purchases satisfies a predetermined condition, and a function of recommending the specific product to a consumer having the specified index value.

Also, JP-A-2020-047156 discloses a product recommendation apparatus that includes: an acquisition unit of acquiring a purchase history representing information on the product purchased by a user and a sales promotion history representing information on the product promoted to the user; a classification unit of using the purchase history and the sales promotion history to classify each product into one of a first group purchased without promotion, a second group purchased with promotion, a third group not purchased without promotion, and a fourth group not purchased with promotion; and a control unit of using the classification result of the classification unit to output a product that is not purchased without sales promotion but is purchased with sales promotion as a product to be recommended to the user.

### SUMMARY

When a similarity relationship between users and a similarity relationship between objects are not considered in calculating a difference between a purchase rate when a recommendation has been made and a purchase rate when a recommendation has not been made, similar items may not be compared with each other and the accuracy is low.

Aspects of non-limiting embodiments of the present disclosure relate to providing an information processing apparatus and a non-transitory computer readable medium that can accurately calculate a difference between a purchase rate when a recommendation has been made and a purchase rate when a recommendation has not been made as compared with a case where the similarity relationship between users and the similarity relationship between objects are not considered.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus includes: a processor configured to: acquire a recommendation history indicating, for a combination of each of any users and each of any objects, whether the object has been recommended to the user, and a selection history indicating, for a combination of each of the any users and each of the any objects, whether the user has selected the object; and calculate, for each of the any objects, a difference between (i) a selection rate when the object has been recommended to similar users of the any users, similarities of the any users to a specific user being obtained based on the recommendation history and the selection history, the similarities of the similar users meeting a predetermined criterion, and (ii) a selection rate when the object has not been recommended to the similar users.

### BRIEF DESCRIPTION OF THE DRAWINGS

Exemplary embodiment(s) of the present disclosure will be described in detail based on the following figures, wherein:

FIG. 1 is a schematic block diagram of an information processing apparatus according to a first exemplary embodiment of the present disclosure;

FIG. 2 is a block diagram illustrating an example of a functional configuration of a ROM or a storage unit of the information processing apparatus according to the first exemplary embodiment of the present disclosure;

FIG. 3 is a block diagram illustrating an example of a functional configuration of the information processing apparatus according to the first exemplary embodiment of the present disclosure;

FIG. 4 is a diagram illustrating an example of calculating similar users according to the first exemplary embodiment of the present disclosure;

FIG. 5 is a diagram illustrating an example of calculating a difference between a purchase rate when a recommendation has been made and a purchase rate when a recommendation has not been made according to the first exemplary embodiment of the present disclosure;

FIGS. 6A and 6B are flowcharts of an example of an operation of the information processing apparatus according to the first exemplary embodiment of the present disclosure;

FIG. 7 is a diagram illustrating an example of calculating similar users according to a modification of the first exemplary embodiment of the present disclosure;

FIG. 8 is a diagram illustrating another example of calculating similar users according to the modification of the first exemplary embodiment of the present disclosure;

FIG. 9 is a diagram illustrating still another example of calculating similar users according to the modification of the first exemplary embodiment of the present disclosure;

FIG. 10 is a diagram illustrating an example of calculating similar items according to a second exemplary embodiment of the present disclosure;

FIG. 11 is a diagram illustrating an example of calculating a difference between a purchase rate when a recommendation has been made and a purchase rate when a recommendation has not been made according to the second exemplary embodiment of the present disclosure;

FIGS. 12A and 12B are flowcharts of an example of an operation of an information processing apparatus according to the second exemplary embodiment of the present disclosure;

FIG. 13 is a diagram illustrating an example of calculating similar items according to a modification of the second exemplary embodiment of the present disclosure;

FIG. 14 is a diagram illustrating another example of calculating similar items according to another modification of the second exemplary embodiment of the present disclosure; and

FIG. 15 is a diagram illustrating another example of calculating similar items according to still another modification of the second exemplary embodiment of the present disclosure.

### DETAILED DESCRIPTION

### First Exemplary Embodiment

Hereinafter, exemplary embodiments of the present disclosure will be described with reference to the accompanying drawings. The same reference numerals will be given to the same or equivalent elements and parts in the drawings. The dimensional ratios in the drawings are exaggerated for convenience of explanation and may be different from the actual ratios.

In the present exemplary embodiment, it is assumed that any object and a specific object are items such as products sold at stores such as supermarkets and online stores on the Internet. In addition to promoting items, recommendations include distribution of coupons and advertisements at stores, posting of advertisements on Internet websites, posting of advertisements on a social networking service (SNS), discounts on items, and posting of advertisements in prominent places such as the cover of catalogs. It is also assumed that selecting of an item is purchasing of the item. In addition to products, items also include news and people. In this case, selecting of an item corresponds to viewing of news and applying for friends to people.

FIG. 1 is a block diagram illustrating a hardware configuration of an information processing apparatus 100. The information processing apparatus 100 is implemented by using, for example, a computer.

As illustrated in FIG. 1, the information processing apparatus 100 includes a central processing unit (CPU) 101, a read only memory (ROM) 102, a random access memory (RAM) 103, a storage unit 104, a communication interface 105, and an input unit 106. The CPU 101 is an example of a processor. The respective units are communicably connected to each other via a bus 107.

The CPU 101 executes various programs and controls the respective units. That is, the CPU 101 reads a program from the ROM 102 or the storage unit 104, and executes the program using the RAM 103 as a work area. The CPU 101 controls each of the above configurations and performs various arithmetic processes according to the program recorded in the ROM 102 or the storage unit 104. In the present exemplary embodiment, the program is stored in the ROM 102 or the storage unit 104.

The ROM 102 stores various programs and various data. The RAM 103 temporarily stores a program or data as a work area. The storage unit 104 is implemented by a hard disk drive (HDD) or a solid state drive (SSD), and stores various programs including an operating system and various data.

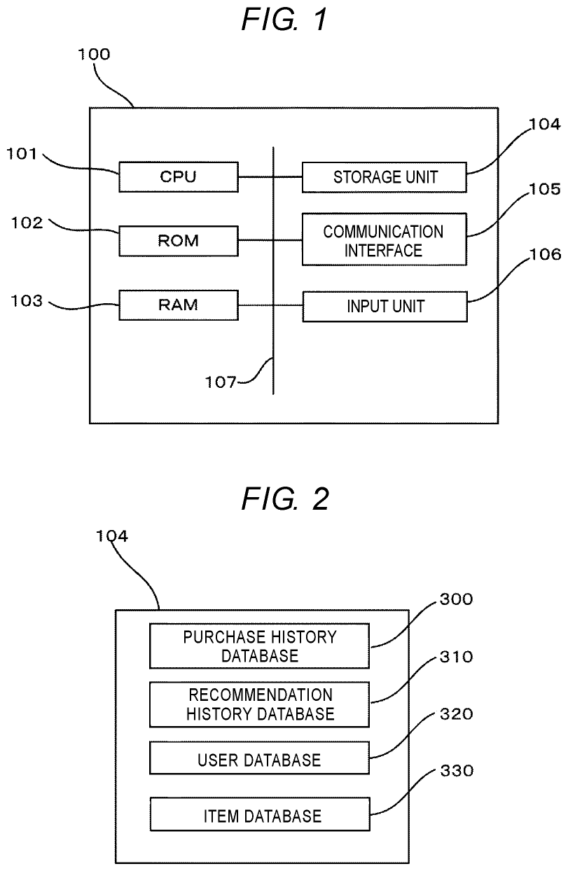

Further, as illustrated in FIG. 2, the storage unit 104 of the information processing apparatus 100 includes storage areas, that is, a purchase history database 300, a recommendation history database 310, a user database 320, and an item database 330. The storage unit 104 stores various data.

The purchase history database 300 stores an item purchase history for each user. The purchase history stores purchase events related to respective items that have been purchased in the past. For example, the purchase history stores IDs and names of the purchased items. The purchase history may further store the numbers of purchases for each purchased item, purchase date, purchase time, weather when purchase was made, the number of people in a group of purchasers (for example, whether an item was purchased by one person or two people), and a place of purchase. Further, the purchase history may be directed only to a store where an item has been purchased. Alternatively, the purchase history may indicate records of purchases made at plural stores or plural different companies.

The recommendation history database 310 stores the recommendation history for each user and each item. The recommendation history stores the IDs and names of the items that have been recommended in the past. The recommendation history may store the recommended date, recommended time, weather when recommendation was made, the number of people in a group of recommended people (for example, whether the items have been purchased by one person or two people), and a place.

Further, when a recommendation is made to a specific user by issuing a coupon, it is considered that the recommendation is made to the specific user.

When a recommendation is made to an unspecified number of users, it may be considered that a recommendation is made to all users.

The user database 320 stores various information about users. For example, the user database 320 may store attributes of a user (such as a name, gender, age, and address of a registered user), information on a questionnaire that was conducted to the user in the past, and a past transaction history. Here, the user is a member of a supermarket or a member of an EC site.

In the user database 320, a user ID is assigned to each user for management.

The user database 320 may not be provided, but the purchase history database 300 may store various information about the users.

To register a user in the user database 320, an administrator may input information using the input unit 106, or a user may input information using a smartphone or a personal computer connected to the information processing apparatus 100.

The item database 330 stores various information about items. For example, the item database 330 stores a name, a description, a price, an image, a field, and a type, for each of items that are currently being sold, each of items that will be sold in the future, and each of items that have been sold in the past. Here, the items are items sold in a supermarket and items sold at an online store on the Internet.

In the item database 330, an item ID is assigned to each item for management.

The item database 330 may not be provided, but the recommendation history database 310 may store information about the items.

To register an item in the item database 330, the administrator may input information using the input unit 106.

The input unit 106 includes a pointing device such as a mouse and a keyboard, and is used to input various information. As will be described later, the input unit 106 is used to input a field of any item, a field of a specific item, a recommended field, and a predetermined criterion.

The communication interface 105 communicates with a client device, for example, a coupon issuing machine in a store, an advertisement display, or another device such as a smartphone or a personal computer of a specific user in online shopping on the Internet. For example, standards such as the public line, the Internet, intranet, Ethernet (registered trademark), FDDI, and Wi-Fi (registered trademark) are used.

The communication interface 105 transmits information, such as a name of a recommended item and an image of the recommended item, to the client device. The communication interface 105 receives coupon usage information and information on purchase in online shopping on the Internet from the client device.

The hardware configuration of the information processing apparatus 100 is not limited to the one described above, but may include other configurations, for example, a configuration for displaying various information based on the control of the CPU 101 such as a liquid crystal display.

The information processing apparatus 100 implements various functions using the above hardware resources. The functional configuration implemented by the information processing apparatus 100 will be described.

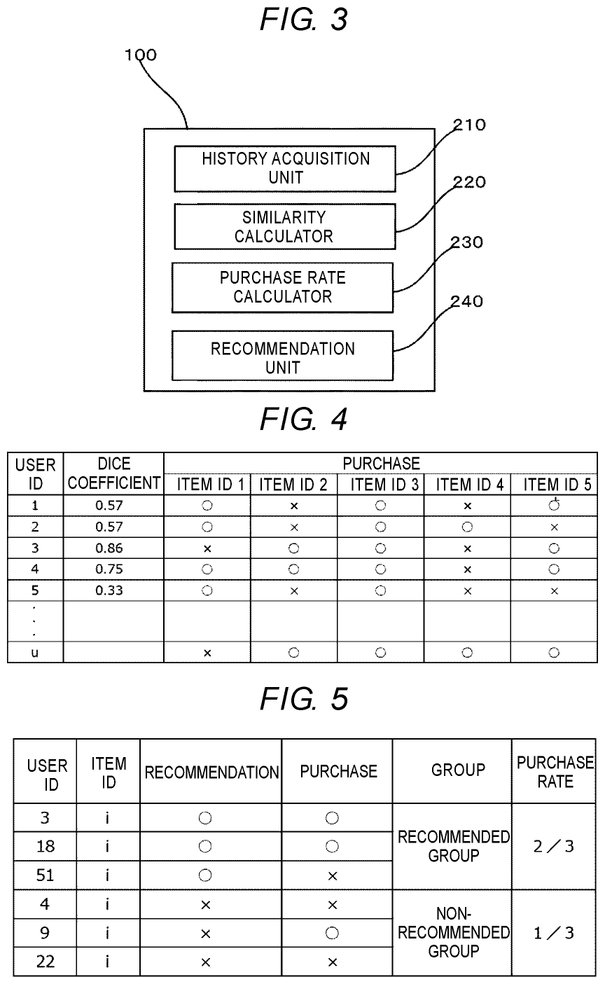

FIG. 3 is a diagram illustrating a functional configuration of the information processing apparatus 100 according to the present exemplary embodiment. The information processing apparatus 100 is an information apparatus that determines an item to be recommended to the user.

As illustrated in FIG. 3, the information processing apparatus 100 includes a history acquisition unit 210, a similarity calculator 220, a purchase rate calculator 230, and a recommendation unit 240 as functional configurations. The CPU 101 reads and executes the program stored in the ROM 102 or the storage unit 104 to implement the respective functional configurations.

The history acquisition unit 210 acquires a recommendation history indicating whether there is a recommendation of an item to a user from the recommendation history database 310 and acquires a purchase history indicating whether the user has purchased the item from the purchase history database 300. The recommendation history and purchase history acquired by the history acquisition unit 210 are used by the similarity calculator 220 and the purchase rate calculator 230.

The similarity calculator 220 calculates a similarity based on the purchase history acquired by the history acquisition unit 210. The similarity is an index used to calculate a similar user who is similar to a specific user among any users. Here, an example of calculating a similar user using a dice coefficient represented by an equation (1) will be described.

$$Dice ( x , y ) = \frac{2 \cdot \vert x ⋂ y \vert}{\vert x \vert + \vert y \vert} \qquad ( 1 )$$

Here, the symbol “x” indicates the set of items purchased by the specific user, and the symbol “y” indicates the set of items purchased by any user. In a case of a store, the specific user may be specified by his/her membership card that he/she presents at the entrance of the store or at the time of accounting. In a case of online shopping on the Internet, the specific user may be specified by a membership ID used for login. The specific user may be a user who is specified by determining, by a clerk, a customer segment (such as an age and a gender) from the appearance of the user at the time of accounting. In this case, the specific user does not specify a certain individual, but specifies an extent to which the user is included in a certain segment.

First, information indicating whether an item has been purchased is acquired from the purchase history database 300. In FIG. 4, the symbol “∘” indicates that purchase has been made, and the symbol “x” indicates that purchase has not been made.

As illustrated in FIG. 4, a similarity between a user u (who is an example of the “specific user”) and a user ID “1” (who is an example of “any user”) is calculated based on whether the user u has purchased each of an item ID “1” to an item ID “5” and whether the user ID “1” has purchased each of the item ID “1” to the item ID “5”. In this example, the number |x| of items purchased by the user u (who is the example of the “specific user”) among the item ID “1” to the item ID “5” is 4. The number of items purchased by the user ID “1” (who is the example of “any user”) among the item ID “1” to the item ID “5” is 3. Thus, the denominator |x|+|y| of the equation (1) is 4+3=7. The number of items commonly purchased by the user u and the user ID “1” among the item ID “1” to the item ID “5” is 2 (that is, the item ID “3” and the item ID “5”). Thus, the numerator 2·|x∩y| of the equation (1) is 2×2=4. Accordingly, the dice coefficient is 4/7, which is about 0.57. Similarly, the number y of items purchased by the user ID “3” (who is the example of “any user”) among the item ID “1” to the item ID “5” is 3. Thus, the denominator |x|+|y| of the equation (1) is 4+3=7. The number of items commonly purchased by the user u and the user ID “3” among the item ID “1” to the item ID “5” is 3 (that is, the item ID “2”, the item ID “3”, and the item ID “5”), the numerator 2·|x∩y| of the equation (1) is 2×3=6. Accordingly, the dice coefficient is 6/7, which is about 0.86.

The dice coefficients are calculated not only for the user ID “1” to the user ID “5” and the item ID “1” to the item ID “5”, but for all users and all items. That is, the dice coefficients are calculated for all the users stored in the user database 320 and all the items for sale stored in the item database 330.

The calculation of the dice coefficient is not limited to calculating the dice coefficients for all users and all items. Any number of users may be extracted, and then the dice coefficients may be calculated for the extracted users. Alternatively, an extraction criterion may be set, users who meet the set criterion may be extracted, and then the dice coefficients may be calculated for the extracted users. Further alternatively, any number of items may be extracted, and then the dice coefficients may be calculated for the extracted items. It is also possible to designate an item field, for example, “food” or “milk”. By designating the field, it is possible to reduce the time and effort required to calculate the dice coefficients. When “food” is designated, it is possible to strengthen sales of food items by making recommendations among the food items. When “milk” is designated, it is possible to strengthen sales among “milk” of different brands.

Then, the users are sorted in descending order of the dice coefficients. Then, users whose similarities to the user u fall within the top “k” users where k is a predetermined number (which is the predetermined criterion) are extracted as similar users having high similarities to the user u as illustrated in FIG. 5 where k is 6. The predetermined number “k” is not limited to 6, but may be 10 or 100.

The purchase rate calculator 230 calculates, for the similar users calculated by the similarity calculator 220, a difference between a purchase rate when any item has been recommended and a purchase rate when none of items has been recommended.

First, the history acquisition unit 210 acquires, from the recommendation history database 310, information indicating whether an item i (which is an example of a specific item) has been recommended to each of the similar users calculated by the similarity calculator 220. The history acquisition unit 210 also acquires, from the purchase history database 300, information indicating whether each of the similar users has purchased the item i. In FIG. 5, the symbol “∘” in a recommendation column indicates that the item i has been recommended, and the symbol “x” in the recommendation column indicates that the item i has not been recommended. Further, the symbol “∘” in a purchase column indicates that the item i has been purchased, and the symbol “x” in the purchase column indicates that the item i has not been purchased.

The purchase rate calculator 230 classifies similar users into groups based on whether the recommendation has been made. In this example, similar users having user IDs “3”, “18”, and “51” are classified into a recommended group, and similar users having user IDs “4”, “9”, and “22” are classified into a non-recommended group.

The purchase rate of the recommended group is “⅔” because 2 out of 3 users have purchased the item i. The purchase rate of the non-recommended group is “⅓” because 1 out of 3 users have purchased the item i.

Then, a difference between the purchase rate when a recommendation has been made and the purchase rate when a recommendation has not been made is calculated. Specifically, the difference between the purchase rate of the recommended group and the purchase rate of the non-recommended group is calculated.

For the item i, the difference is ⅔−⅓=⅓. Therefore, it is found that the item i is a product that provides a recommendation effect of ⅓ when the item i is recommended. A difference between the purchase rate when a recommendation has been made and the purchase rate when a recommendation has not been made is calculated for each of all the items for sale stored in the item database 330 in addition to the item i, to find items each having a large difference in the purchase rate. It can be said that an item having such a large difference is an item that with a high recommendation effect.

The differences may not be calculated for all items. An item field may be designated, and a difference may be calculated for items included in the designated field.

The recommendation unit 240 recommends an item having a large difference in purchase rate calculated by the purchase rate calculator 230 to the specific user (specifically, the user u). For example, the recommendation unit 240 recommends an item having the largest difference to the specific user (specifically, the user u).

Here, as described above, the recommendation is typically, but is not limited to, the distribution of coupons and advertisements at stores and the posting of advertisements on Internet web sites.

The recommendation is not limited to recommending the item having the largest difference. Alternatively, the top three items in the difference may be recommended, or the item having the largest difference among the items in the designated field may be recommended. The differences in the purchase rate may not be calculated for all the items. Alternatively, a field of the specific item (for example, “food” or “milk”) may be designated. By doing so, it is possible to reduce the time and effort required to determine an item with a high recommendation effect.

Next, an operation of the information processing apparatus 100 will be described.

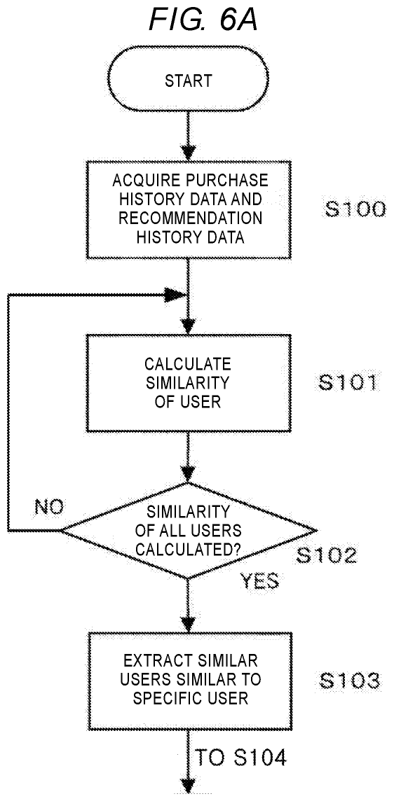

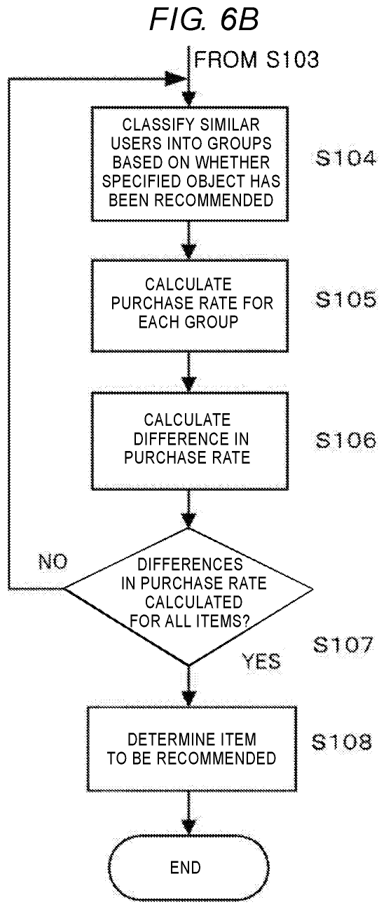

FIGS. 6A and 6B are flowcharts of an example of an operation of the information processing apparatus 100 according to a first exemplary embodiment.

In step S100, the CPU 101 acquires purchase history data from the purchase history database 300, and acquires recommendation history data from the recommendation history database 310.

In step S101, the CPU 101 calculates a similarity between a specific user and any user.

In step S102, the CPU 101 determines whether the similarities between the specific user and all the users have been calculated. When determining that the similarities with all users have been calculated, the CPU 101 proceeds to next step S103. When determining that the similarities with all users have not been calculated, the CPU 101 returns to step S101.

In step S103, the CPU 101 extracts similar users having high similarities to the specific user based on the similarities calculated in step S101.

In step S104, the CPU 101 classifies the similar users into (i) a recommended group to which a specific item has been recommended and (ii) a non-recommended group to which the specific item has not been recommended, based on the recommendation column in the recommendation history.

In step S105, the CPU 101 calculates a purchase rate for each of the groups into which the similar users are classified in step S104.

In step S106, the CPU 101 calculates a difference between the purchase rate of the recommended group (calculated in step S105) and the purchase rate of the non-recommended group (calculated in step S105).

In step S107, the CPU 101 determines whether the differences in purchase rate have been calculated for all the items. When determining that the differences in the purchase rate have been calculated for all the items, the CPU 101 proceeds to next step S108. When determining that the differences in purchase rate have not been calculated for all the items, the CPU 101 returns to step S104.

In step S108, the CPU 101 determines an item having a large difference in purchase rate (calculated in step S106) as an item to be recommended.

### Modifications

The present disclosure is not limited to the first exemplary embodiment described above. Various modifications may be made or the present disclosure may be applied in various manner without departing from the gist of the present disclosure.

In the first exemplary embodiment, the description has been made on the example in which the similarity calculator 220 calculates similar users based on the similarities calculated based on the purchase history acquired by the history acquisition unit 210. The present disclosure is not limited thereto. The similar users may be calculated based on similarities that are calculated based on the recommendation history, regardless of whether an item has been purchased as a result of recommendation.

Here, it is assumed that the symbol “x” in the equation (1) indicates the set of items recommended to a specific user, and the symbol “y” in the equation (1) indicates the set of items recommended to any user.

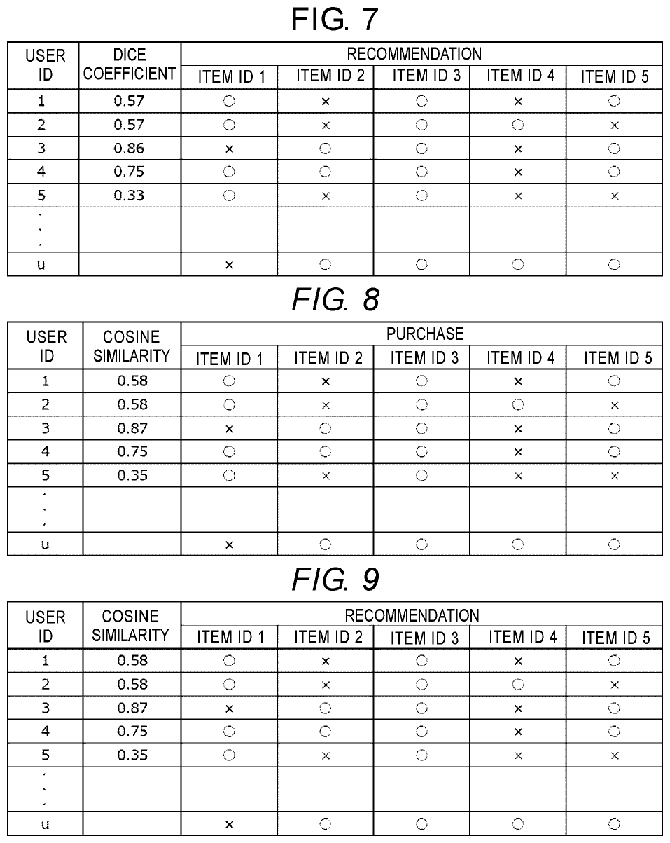

First, information indicating whether the items have been recommended is acquired from the recommendation history database 310. In FIG. 7, the symbol “∘” indicates that recommendation has been made, and the symbol “x” indicates that recommendation has not been made.

As illustrated in FIG. 7, a similarity between the user u (who is the example of the “specific user”) and the user ID “1” (who is the example of “any user”) is calculated based on whether each of an item ID “1” to an item ID “5” has been recommended to the user u and whether each of the item ID “1” to the item ID “5” has been recommended to the user ID “1”. In this example, the number |x| of items recommended to the user u (who is the example of the “specific user”) among the item ID “1” to the item ID “5” is 4. The number of items recommended to the user ID “1” (who is the example of “any user”) among the item ID “1” to the item ID “5” is 3. Thus, the denominator |x|+|y| of the equation (1) is 4+3=7. Further, since the number of items commonly recommended to the user u and the user ID “1” among the item ID “1” to the item ID “5” is 2. Thus, the numerator 2·|x∩y| of the equation (1) is 2×2=4. Accordingly, the dice coefficient is 4/7, which is about 0.57.

The dice coefficients are calculated not only for the user ID “1” to the user ID “5” and the item ID “1” to the item ID “5”, but for all users and all items. That is, the dice coefficients are calculated for all the users stored in the user database 320 and all the items for sale stored in the item database 330.

The calculation of the dice coefficient is not limited to calculating the dice coefficients for all users and all items. Any number of users may be extracted, and then the dice coefficients may be calculated for the extracted users. Alternatively, an extraction criterion may be set, users who meet the set criterion may be extracted, and then the dice coefficients may be calculated for the extracted users. Further alternatively, any number of items may be extracted, and then the dice coefficients may be calculated for the extracted items. It is also possible to designate an item field, for example, “food” or “milk”. By designating the field, it is possible to reduce the time and effort required to calculate the dice coefficients. When “food” is designated, it is possible to strengthen sales of food items by making recommendations among the food items. When “milk” is designated, it is possible to strengthen sales among “milk” of different brands.

Then, the users are sorted in descending order of the dice coefficients. Then, users whose similarities to the user u fall within the top “k” users where k is a predetermined number (which is the predetermined criterion) are extracted as similar users having high similarities to the user u as illustrated in FIG. 5 where k is 6. The predetermined number “k” is not limited to 6, but may be 10 or 100.

The processes performed by the purchase rate calculator 230 and the recommendation unit 240 after the above described process is the same as those in the case where the purchase history is used. Thus, the description thereof will be omitted.

In the first exemplary embodiment, the description have been made on the example in which the similarity calculator 220 calculates similar users using the dice coefficients represented by the equation (1). The present disclosure is not limited to thereto. The similar users may be calculated using, for example, cosine similarities. Here, description will be made on an example in which a similar user is calculated using the cosine similarity represented by the equation (2) with reference to FIG. 8.

$$cos ( x , y ) = \frac{\vec{x} \cdot \vec{y}}{\vert \vec{x} \vert \cdot \vert \vec{y} \vert} \qquad ( 2 )$$

First, information indicating whether an item has been purchased is acquired from the purchase history database 300. In FIG. 8, the symbol “∘” indicates that purchase has been made, and the symbol “x” indicates that purchase has not been made.

As illustrated in FIG. 8, a similarity between the user u (who is the example of the “specific user”) and the user ID “1” (who is the example of “any user”) is calculated based on whether the user u has purchased each of the item ID “1” to the item ID “5” and whether the user ID “1” has purchased each of the item ID “1” to the item ID “5”. In this example, a vector x indicating items purchased by the user u (who is the example of the “specific user”) among the item ID “1” to the item ID “5” is (0, 1, 1, 1, 1). A vector y indicating items purchased by the user ID “1” (who is the example of “any user”) among the item ID “1” to the item ID “5” is (1, 0, 1, 0 ,1). Thus, the denominator of the equation (2) is 2\sqrt{3}. The numerator of the equation (2) is 2. Accordingly, the cosine similarity is 2/2\sqrt{3}, which is about 0.58.

The cosine similarities are calculated not only for the user ID “1” to the user ID “5” and the item ID “1” to the item ID “5”, but for all users and all items. That is, the cosine similarities are calculated for all the users stored in the user database 320 and all the items for sale stored in the item database 330.

The calculation of the cosine similarities is not limited to calculating the cosine similarities for all users and all items. Any number of users may be extracted, and then the cosine similarities may be calculated for the extracted users. Alternatively, an extraction criterion may be set, users who meet the set criterion may be extracted, and then the cosine similarities may be calculated for the extracted users. Further alternatively, any number of items may be extracted, and then the cosine similarities may be calculated for the extracted items. It is also possible to designate an item field, for example, “food” or “milk”. By designating the field, it is possible to reduce the time and effort required to calculate the cosine similarities. When “food” is designated, it is possible to strengthen sales of food items by making recommendations among the food items. When “milk” is designated, it is possible to strengthen sales among “milk” of different brands.

Then, the users are sorted in descending order of the cosine similarities. Users whose similarities to the user u fall within the top “k” users where k is a predetermined number (which is the predetermined criterion) are extracted as similar users having high similarities to the user u as illustrated in FIG. 5 where k is 6. The predetermined number “k” is not limited to 6, but may be 10 or 100.

The processes performed by the purchase rate calculator 230 and the recommendation unit 240 after the above described process is the same as those in the case where the dice coefficients are used. Thus, the description thereof will be omitted.

In the first exemplary embodiment, the description has been made on the example in which the similarity calculator 220 calculates similar users using the dice coefficients based on the purchase history acquired by the history acquisition unit 210. The present disclosure is not limited to this. The similar user may be calculated using, for example, cosine similarities based on the recommendation history.

Here, the vector “x” in the equation (2) indicates items recommended to a specific user, and the vector “y” in the equation (2) indicates items recommended to any user.

First, information indicating whether the items have been recommended is acquired from the recommendation history database 310. In FIG. 9, the symbol “∘” indicates that recommendation has been made, and the symbol “x” indicates that recommendation has not been made.

As illustrated in FIG. 9, a similarity between the user u (who is the example of the “specific user”) and the user ID “1” (who is the example of “any user”) is calculated based on whether each of an item ID “1” to an item ID “5” has been recommended to the user u and whether each of the item ID “1” to the item ID “5” has been recommended to the user ID “1”. In this example, the vector x indicating items recommended to the user u (who is the example of the “specific user”) among the item ID “1” to the item ID “5” is (0, 1, 1, 1, 1). The vector y indicating items recommended to the user ID “1” (who is the example of “any user”) among the item ID “1” to the item ID “5” is (1, 0, 1, 0 ,1). Thus, the denominator of the equation (2) is 2\sqrt{3}. The numerator of the equation (2) is 2. Accordingly, the cosine similarity is 2/2\sqrt{3}, which is about 0.58.

The cosine similarities are calculated not only for the user ID “1” to the user ID “5” and the item ID “1” to the item ID “5”, but for all users and all items. That is, the cosine similarities are calculated for all the users stored in the user database 320 and all the items for sale stored in the item database 330.

The calculation of the cosine similarities is not limited to calculating the cosine similarities for all users and all items. Any number of users may be extracted, and then the cosine similarities may be calculated for the extracted users. Alternatively, an extraction criterion may be set, users who meet the set criterion may be extracted, and then the cosine similarities may be calculated for the extracted users. Further alternatively, any number of items may be extracted, and then the cosine similarities may be calculated for the extracted items. It is also possible to designate an item field, for example, “food” or “milk”. By designating the field, it is possible to reduce the time and effort required to calculate the cosine similarities. When “food” is designated, it is possible to strengthen sales of food items by making recommendations among the food items. When “milk” is designated, it is possible to strengthen sales among “milk” of different brands.

Then, the users are sorted in descending order of the cosine similarities. Users whose similarities to the user u fall within the top “k” users where k is a predetermined number (which is the predetermined criterion) are extracted as similar users having high similarities to the user u as illustrated in FIG. 5 where k is 6. The predetermined number “k” is not limited to 6, but may be 10 or 100.

The processes performed by the purchase rate calculator 230 and the recommendation unit 240 after the above described process is the same as those in the case where the dice coefficients are used. Thus, the description thereof will be omitted.

In the first exemplary embodiment, the description has been made on the example in which the program is stored (installed) in the ROM 102 or the storage unit 104 in advance. The present disclosure is not limited thereto. The program is provided in a form recorded on a recording medium such as a compact disk read only memory (CD-ROM), a digital versatile disk only memory (DVD-ROM), or a universal serial bus (USB) memory. The program may be downloaded from an external device via a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Second Exemplary Embodiment

Next, a second exemplary embodiment will be described.

In the first exemplary embodiment described above, similar users similar to a specific user are calculated, and items to be recommended are determined based on the purchase rate of the similar users. In the second exemplary embodiment, similar items similar to a specific item are calculated, and items to be recommended are determined based on the purchase rate of the similar items.

In the second exemplary embodiment, differences from the first exemplary embodiment will be described, and redundant description will be simplified or omitted.

In the present exemplary embodiment, the similarity calculator 220 calculates similarities based on the purchase history acquired by the history acquisition unit 210. The similarity is an index used to calculate a similar item that is similar to a specific item among any items. Here, an example of calculating a similar item using the dice coefficient of the equation (1) will be described.

Here, the symbol “x” indicates the set of users who have purchased the specific item, and the symbol “y” indicates the set of users who have purchased any item. The specific item is an item randomly extracted from the items stored in the item database 330.

The specific item is not limited to the item which is randomly extracted from all the items stored in the item database 330. Alternatively, an item field may be designated, and an item may be randomly extracted from items in the designated field.

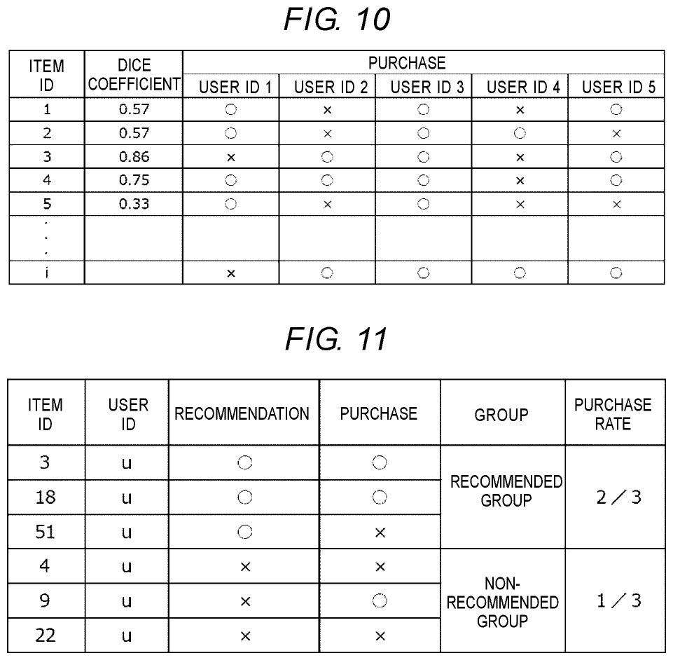

First, information indicating whether an item has been purchased is acquired from the purchase history database 300. In FIG. 10, the symbol “∘” indicates that purchase has been made, and the symbol “x” indicates that purchase has not been made.

As illustrated in FIG. 10, the similarity between an item i (which is an example of the “specific item”) and an item ID “1” (which is an example of “any item”) is calculated based on whether each of the user ID “1” to the user ID “5” has purchased the specific item and whether each of the user ID “1” to the user ID “5” has purchased the item ID “1”. In this example, the number of times the item i (which is the example of the specific item) has been purchased by the user ID “1” to the user ID “5” is 4, and the number of times the item ID “1” (which is the example of “any item”) has been purchased by the user ID “1” to the user ID “5” is 3. Thus, the denominator |x|+|y| of equation (1) is 4+3=7. The number of users who have commonly purchased the item “i” and the item ID “1” among the user ID “1” to the user ID “5” (that is, the user ID “3” and the user ID “5”) is 2. Thus, the numerator 2·|x∩y| of the equation (1) is 2×2=4. Accordingly, the dice coefficient is 4/7, which is about 0.57.

The dice coefficients are calculated not only for the item ID “1” to the item ID “5” and the user ID “1” to the user ID “5”, but also for all the items and all the users. That is, the dice coefficients are calculated for all the items for sale stored in the item database 330 and all the users stored in the user database 320.

The calculation of the dice coefficients is not limited to calculating the dice coefficients for all the items and all the users. Any number of items may be extracted, and then the dice coefficients may be calculated for the extracted items. Alternatively, an extraction criterion may be set, items that meet the extraction criterion may be extracted, and then the dice coefficients may be calculated for the extracted items. Further alternatively, any number of users may be extracted, and then the dice coefficients may be calculated for the extracted users. It is also possible to designate an item field, for example, “food” or “milk”. By designating the field, it is possible to reduce the time and effort required to calculate the dice coefficients. When “food” is designated, it is possible to strengthen sales of food items by making recommendations among the food items. When “milk” is designated, it is possible to strengthen sales among “milk” of different brands.

Then, the items are sorted in descending order of the dice coefficients. Items whose similarities to the item i fall within the top “m” items where m is a predetermined number (which is the predetermined criterion) are extracted as similar items having high similarities to the item i as illustrated in FIG. 11 where m is 6. The predetermined number “m” is not limited to 6 and may be 10 or 100.

The purchase rate calculator 230 calculates a difference between a purchase rate when the similar item calculated by the similarity calculator 220 has been recommended to a specific user and a purchase rate when the similar item calculated by the similarity calculator 220 has not been recommended to the specific user.

Here, the specific user is a target user to whom this item is to be recommended. In the case of a store, the specific user is a user who presents a membership card at the entrance of the store or at the time of accounting. In the case of online shopping on the Internet, the specific user is a user who is specified by the membership ID used for login.

First, the history acquisition unit 210 acquires, from the recommendation history database 310, information indicating whether the similar items calculated by the similarity calculator 220 has been recommended to a user u (who is an example of the specific user). The history acquisition unit 210 also acquires, from the purchase history database 300, information indicating whether the user u purchased the similar items. In FIG. 11, the symbol “∘” in a recommendation column indicates that an item has been recommended, and the symbol “x” in the recommendation column indicates that an item has not been recommended. Further, the symbol “∘” in a purchase column indicates that an item has been purchased, and the symbol “x” in the purchase column indicates that an item has not been purchased.

The purchase rate calculator 230 classifies similar items into groups based on whether recommendation has been made. In this example, similar items having item IDs “3”, “18”, and “51” are classified into a recommended group, and similar items with item IDs “4”, “9”, and “22” are classified into a non-recommended group.

The purchase rate of the recommended group is “⅔” because 2 out of 3 have been purchased, and the purchase rate of the non-recommended group is “⅓” because 1 out of 3 has been purchased.

Then, a difference between the purchase rate when a recommendation has been made and the purchase rate when a recommendation has not been made is calculated. Specifically, the difference between the purchase rate of the recommended group and the purchase rate of the non-recommended group is calculated.

The difference in purchase rate at which the user u has purchased the similar items=⅔−⅓=⅓. Therefore, it is found that a recommendation effect of ⅓ is obtained when an item is recommended to the user u. A difference between the purchase rate when a recommendation has been made and the purchase rate when a recommendation has not been made is calculated for each of all the items for sale stored in the item database 330 in addition to the item i, to find items each having a large difference in the purchase rate. It can be said that an item having such a large difference is an item that with a high recommendation effect.

The differences may not be calculated for all items. An item field may be designated, and differences may be calculated for items included in the designated field.

Next, an operation of the information processing apparatus 100 will be described.

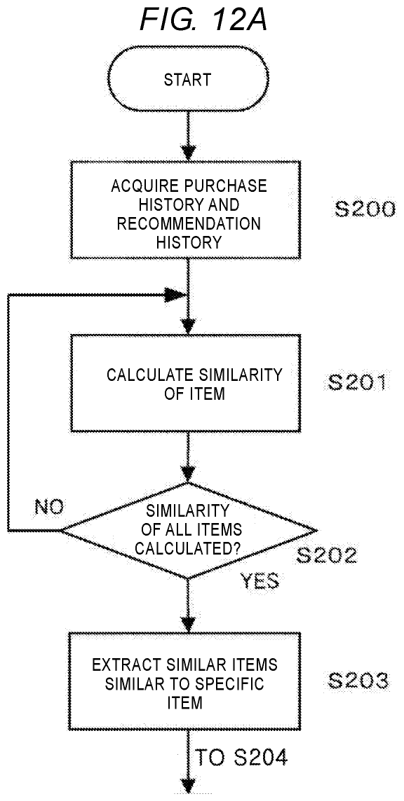

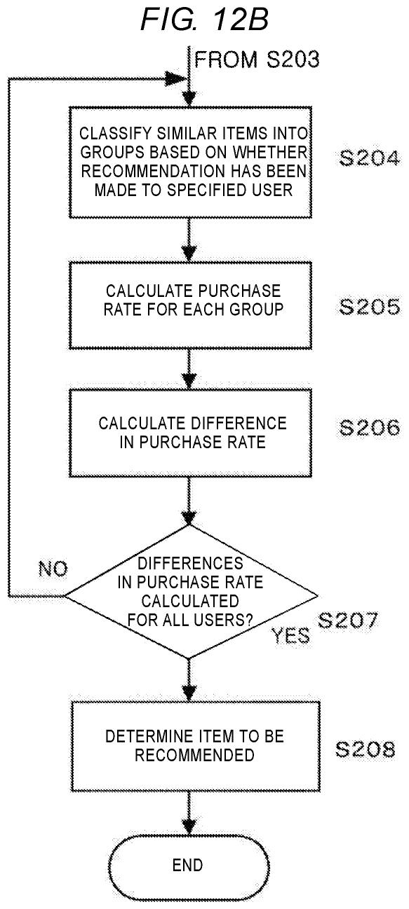

FIGS. 12A and 12B are flowcharts of an example of an operation of the information processing apparatus 100 of the second exemplary embodiment.

In step S200, the CPU 101 acquires purchase history data from the purchase history database 300, and acquires recommendation history data from the recommendation history database 310.

In step S201, the CPU 101 calculates a similarity between a specific item and any item.

In step S202, the CPU 101 determines whether the similarities between the specific item and all the items have been calculated. When determining that the similarities of all items have been calculated, the CPU 101 proceeds to next step S203. When the CPU 101 determines that the similarities to all items have not been calculated, the CPU 101 returns to step S201.

In step S203, the CPU 101 extracts similar items having high similarities to the specific item based on the similarities calculated in step S201.

In step S204, the CPU 101 classifies the similar items into (i) a recommended group in which items have been recommended to a specific user and (ii) a non-recommended group in which items have not been recommended to the specific user, based on the recommendation column in the recommendation history.

In step S205, the CPU 101 calculates a purchase rate for each of the groups into which the similar items are classified in step S204.

In step S206, the CPU 101 calculates a difference between the purchase rate of the recommended group (calculated in step S205) and the purchase rate of the non-recommended group (calculated in step S205).

In step S207, the CPU 101 determines whether the differences in purchase rate have been calculated for all the users. When determining that the differences in the purchase rate have been calculated for all the users, the CPU 101 proceeds to next step S208. When determining that the differences in purchase rate have not been calculated for all the users, the CPU 101 returns to step S204.

In step S208, the CPU 101 determines an item having a large difference in purchase rate (calculated in step S206) as an item to be recommended.

### Modifications

The present disclosure is not limited to the second exemplary embodiment described above. Various modifications may be made or the present disclosure may be applied in various manner without departing from the gist of the present disclosure.

In the second exemplary embodiment, the description has been made on the example in which the similarity calculator 220 calculates similar items based on the similarities calculated based on the purchase history acquired by the history acquisition unit 210. The present disclosure is not limited thereto. The similar items may be calculated based on similarities that are calculated based on the recommendation history, regardless of whether an item has been purchased as a result of recommendation.

Here, the symbol “x” in the above-mentioned equation (1) indicates the set of users to whom a specific item has been recommended, and the symbol “y” indicates the set of users to whom any item has been recommended.

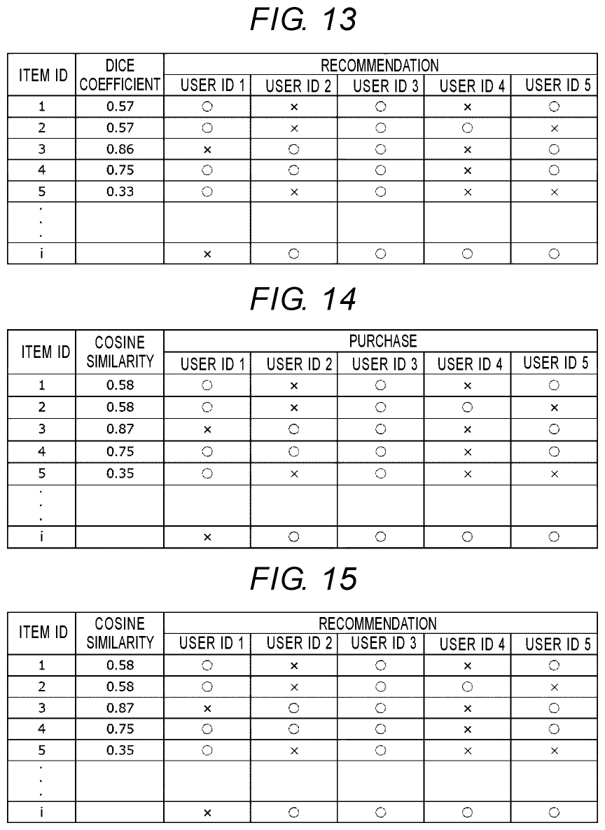

First, information indicating whether the items have been recommended is acquired from the recommendation history database 310. In FIG. 13, the symbol “∘” indicates that recommendation has been made, and the symbol “x” indicates that recommendation has not been made.

As illustrated in FIG. 13, the similarity between an item i (which is an example of the “specific item”) and an item ID “1” (which is an example of “any item”) is calculated based on whether the item i has been recommended to each of the user ID “1” to the user ID “5” and whether the item ID “1” has been recommended to each of the user ID “1” to the user ID “5”. In this example, the number |x| of times the item i (which is the example of the “specific item”) has been recommended to the user ID “1” to the user ID “5” is 4. The number of times the item ID “1” (which is the example of “any item”) has been recommended to the user ID “1” to the user ID “5” is 3. Thus, the denominator |x|+|y| of the equation (1) is 4+3=7. The number of users to whom the item “i” and the item ID “1” have been commonly recommended among the user ID “1” to the user ID “5” (that is, the user ID “3” and the user ID “5”) is 2. Thus, the numerator 2·|x∩y| of the equation (1) is 2×2=4. Accordingly, the dice coefficient is 4/7, which is about 0.57.

The dice coefficients are calculated not only for the item ID “1” to the item ID “5” and the user ID “1” to the user ID “5”, but also for all the items and all the users. That is, the dice coefficients are calculated for all the items for sale stored in the item database 330 and all the users stored in the user database 320.

The calculation of the dice coefficients is not limited to calculating the dice coefficients for all the items and all the users. Any number of items may be extracted, and then the dice coefficients may be calculated for the extracted items. Alternatively, an extraction criterion may be set, items that meet the extraction criterion may be extracted, and then the dice coefficients may be calculated for the extracted items. Further alternatively, any number of users may be extracted, and then the dice coefficients may be calculated for the extracted users. It is also possible to designate an item field, for example, “food” or “milk”. By designating the field, it is possible to reduce the time and effort required to calculate the dice coefficients. When “food” is designated, it is possible to strengthen sales of food items by making recommendations among the food items. When “milk” is designated, it is possible to strengthen sales among “milk” of different brands.

Then, the items are sorted in descending order of the dice coefficients. Items whose similarities to the item i fall within the top “m” items where m is a predetermined number (which is the predetermined criterion) are extracted as similar items having high similarities to the item i as illustrated in FIG. 11 where m is 6. The predetermined number is not limited to 6 and may be 10 or 100.

The processes performed by the purchase rate calculator 230 and the recommendation unit 240 after the above described process is the same as those in the case where the purchase history is used. Thus, the description thereof will be omitted.

In the second exemplary embodiment, the description has been made on the example in which the similarity calculator 220 calculates similar items using the dice coefficients represented by the equation (1). The present disclosure is not limited to thereto. The similar items may be calculated using, for example, cosine similarities. Here, description will be made on an example in which a similar item is calculated using the cosine similarity represented by the equation (2) with reference to FIG. 14.

First, information indicating whether an item has been purchased is acquired from the purchase history database 300. In FIG. 14, the symbol “∘” indicates that purchase has been made, and the symbol “x” indicates that purchase has not been made.

As illustrated in FIG. 14, the similarity between the item i (which is the example of the “specific item”) and an item ID “1” (which is the example of “any item”) is calculated based on whether the item i has been purchased by each of the user ID “1” to the user ID “5” and whether the item ID “1” has been purchased by each of the user ID “1” to the user ID “5”. In this example, a vector x indicating users among the user ID “1” to the user ID “5” who have purchased the item i (which is the example of the “specific item”) is (0, 1, 1, 1, 1). A vector y indicating users among the user ID “1” to the user ID “5” who have purchased the item ID “1” (which is the example of “any item”) is (1, 0, 1, 0 ,1). Thus, the denominator of the equation (2) is 2\sqrt{3}. The numerator of the equation (2) is 2. Accordingly, the cosine similarity is 2/2\sqrt{3}, which is about 0.58.

The cosine similarities are calculated not only for the item ID “1” to the item ID “5” and the user ID “1” to the user ID “5”, but for all the items and all the users. That is, the cosine similarities are calculated for all the users stored in the user database 320 and all the items for sale stored in the item database 330.

The calculation of the cosine similarities is not limited to calculating the cosine similarities for all users and all items. Any number of users may be extracted, and then the cosine similarities may be calculated for the extracted users. Alternatively, an extraction criterion may be set, users who meet the set criterion may be extracted, and then the cosine similarities may be calculated for the extracted users. Further alternatively, any number of items may be extracted, and then the cosine similarities may be calculated for the extracted items. It is also possible to designate an item field, for example, “food” or “milk”. By designating the field, it is possible to reduce the time and effort required to calculate the cosine similarities. When “food” is designated, it is possible to strengthen sales of food items by making recommendations among the food items. When “milk” is designated, it is possible to strengthen sales among “milk” of different brands.

Then, the items are sorted in descending order of the cosine similarities. Items whose similarities to the item i fall within the top “m” items where m is a predetermined number (which is the predetermined criterion) are extracted as similar items having high similarities to the item i as illustrated in FIG. 11 where m is 6. The predetermined number is not limited to 6 and may be 10 or 100.

The processes performed by the purchase rate calculator 230 and the recommendation unit 240 after the above described process is the same as those in the case where the dice coefficients are used. Thus, the description thereof will be omitted.

In the second exemplary embodiment, the description has been made on the example in which the similarity calculator 220 calculates similar items using the dice coefficient based on the purchase history acquired by the history acquisition unit 210. The present disclosure is not limited thereto. The similar items may be calculated using the cosine similarity based on the recommendation history.

Here, the vector “x” in the equation (2) indicates users to whom a specific item has been recommended, and the vector “y” in the equation (2) indicates users to whom any item has been recommended.

First, information indicating whether the items have been recommended is acquired from the recommendation history database 310. In FIG. 15, the symbol “∘” indicates that recommendation has been made, and the symbol “x” indicates that recommendation has not been made.

As illustrated in FIG. 15, the similarity between an item i (which is an example of the “specific item”) and an item ID “1” (which is an example of “any item”) is calculated based on whether the item i has been recommended to each of the user ID “1” to the user ID “5” and whether the item ID “1” has been recommended to each of the user ID “1” to the user ID “5”. In this example, the vector x indicating users among the user ID “1” to the user ID “5” to whom the item i (which is the example of the “specific item”) has been recommended is (0, 1, 1, 1, 1). The vector y indicating users among the user ID “1” to the user ID “5” to whom the item ID “1” (which is the example of “any item”) has been recommended is (1, 0, 1, 0 ,1). Thus, the denominator of the equation (2) is 2\sqrt{3}. The numerator of the equation (2) is 2. Accordingly, the cosine similarity is 2/2\sqrt{3}, which is about 0.58.

The cosine similarities are calculated not only for the item ID “1” to the item ID “5” and the user ID “1” to the user ID “5”, but for all the items and all the users. That is, the cosine similarities are calculated for all the users stored in the user database 320 and all the items for sale stored in the item database 330.

The calculation of the cosine coefficients is not limited to calculating the cosine coefficients for all users and all items. Any number of users may be extracted, and then the cosine coefficients may be calculated for the extracted users. Alternatively, an extraction criterion may be set, users who meet the set criterion may be extracted, and then the cosine coefficients may be calculated for the extracted users. Further alternatively, any number of items may be extracted, and then the cosine coefficients may be calculated for the extracted items. It is also possible to designate an item field, for example, “food” or “milk”. By designating the field, it is possible to reduce the time and effort required to calculate the cosine similarities. When “food” is designated, it is possible to strengthen sales of food items by making recommendations among the food items. When “milk” is designated, it is possible to strengthen sales among “milk” of different brands.

Then, the items are sorted in descending order of the cosine similarities. Items whose similarities to the item i fall within the top “m” items where m is a predetermined number (which is the predetermined criterion) are extracted as similar items having high similarities to the item i as illustrated in FIG. 11 where m is 6. The predetermined number is not limited to 6 and may be 10 or 100.

The processes performed by the purchase rate calculator 230 and the recommendation unit 240 after the above described process is the same as those in the case where the dice coefficients are used. Thus, the description thereof will be omitted.

### Others

In the above-described exemplary embodiments, the difference in the purchase rate is calculated based on the similarities of the users and the similarities of the items, and an item is recommended. The present disclosure is not limited thereto. The difference in the purchase rate may be calculated based on a similarity of a situation such as, for example, a season, weather, the number of people who visited a shop, date, and presence or absence of an event, and an item may be recommended.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
acquire
a recommendation history indicating, for a combination of each of any users and each of any objects, whether the object has been recommended to the user, and
a selection history indicating, for a combination of each of the any users and each of the any objects, whether the user has selected the object; and
calculate, for each of the any objects, a difference between (i) a selection rate when the object has been recommended to similar users of the any users, similarities of the any users to a specific user being obtained based on the recommendation history and the selection history, the similarities of the similar users meeting a predetermined criterion, and (ii) a selection rate when the object has not been recommended to the similar users.

2. An information processing apparatus comprising:
a processor configured to:
acquire
a recommendation history indicating, for a combination of each of any users and each of any objects, whether the object has been recommended to the user, and
a selection history indicating, for a combination of each of the any users and each of the any objects, whether the user has selected the object; and
calculate a difference between (i) a selection rate when similar objects of the any objects have been recommended to a specific user, similarities of the any objects to a specific object being obtained based on the recommendation history and the selection history, the similarities of the similar objects meeting a predetermined criterion, and (ii) a selection rate when the similar objects have not been recommended to the specific user.

3. The information processing apparatus according to claim 1, wherein
the processor is configured to recommend an object having a large difference in the selection rate to the specific user.

4. The information processing apparatus according to claim 2, wherein
the processor is configured to recommend an object having a large difference in the selection rate to the specific user.

5. The information processing apparatus according to claim 1, wherein
the processor is configured to calculate, for each of the any objects, the difference in the selection rate by
classifying the similar users into a recommended group and a non-recommended group based on whether the object has been recommended, and
calculating a difference between the selection rate of the recommended group and the selection rate of the non-recommended group.

6. The information processing apparatus according to claim 3, wherein
the processor is configured to calculate, for each of the any objects, the difference in the selection rate by
classifying the similar users into a recommended group and a non-recommended group based on whether the object has been recommended, and
calculating a difference between the selection rate of the recommended group and the selection rate of the non-recommended group.

7. The information processing apparatus according to claim 2, wherein
the processor is configured to calculate the difference in the selection rate by
classifying the similar objects into a recommended group and a non-recommended group, and
calculating a difference between the selection rate of the recommended group and the selection rate of the non-recommended group.

8. The information processing apparatus according to claim 4, wherein
the processor is configured to calculate the difference in the selection rate by
classifying the similar objects into a recommended group and a non-recommended group, and
calculating a difference between the selection rate of the recommended group and the selection rate of the non-recommended group.

9. The information processing apparatus according to claim 1, wherein
the processor is configured to receive a field of the any objects.

10. The information processing apparatus according to claim 2, wherein
the processor is configured to receive a field of the any objects.

11. The information processing apparatus according to claim 3, wherein
the processor is configured to receive a field of the any objects.

12. The information processing apparatus according to claim 4, wherein
the processor is configured to receive a field of the any objects.

13. The information processing apparatus according to claim 5, wherein
the processor is configured to receive a field of the any objects.

14. The information processing apparatus according to claim 6, wherein
the processor is configured to receive a field of the any objects.

15. The information processing apparatus according to claim 2, wherein
the processor is configured to receive a field of the specific object.

16. The information processing apparatus according to claim 3, wherein
the processor is configured to receive a field of the recommended objects.

17. The information processing apparatus according to claim 1, wherein
the predetermined criterion is that the similar users fall within top k users among the any users where k is a predetermined number.

18. The information processing apparatus according to claim 2, wherein
the predetermined criterion is that the similar objects fall within a top m objects among the any objects where m is a predetermined number.

19. The information processing apparatus according to claim 1, wherein
the processor is configured to calculate dice coefficients or cosine similarities as the similarities.

20. A non-transitory computer readable medium storing a program that causes a computer to execute information processing, the information processing comprising:
acquiring
a recommendation history indicating, for a combination of each of any users and each of any objects, whether the object has been recommended to the user, and
a selection history indicating, for a combination of each of the any users and each of the any objects, whether the user has selected the object; and
calculating, for each of the any objects, a difference between (i) a selection rate when the object has been recommended to similar users of the any users, similarities of the any users to a specific user being obtained based on the recommendation history and the selection history, the similarities of the similar users meeting a predetermined criterion, and (ii) a selection rate when the object has not been recommended to the similar users.
